(19) United States
(12) Patent Application Publication
(10) Pub. No.: US 2005/0065983 A1
(43) Pub. Date: Mar. 24, 2005

(54) Extracting record content

(76) Inventors: Peng Wang, Walldorf (DE); Peter Weddeling, Sinsheim (DE); Peter Sieber, Wiesloch (DE); Jose Gonzalez Seco, Walldorf (DE); Sandra Fusser, Bad Schoenborn (DE); Oswald Gschnitzer, Heidelberg (DE)

Correspondence Address: FISH & RICHARDSON, P.C., 3300 DAIN RAUSCHER PLAZA, 60 SOUTH SIXTH STREET, MINNEAPOLIS, MN, 55402, US

(21) Appl. No.: 10/666,942

(22) Filed: Sep. 19, 2003

(51) Int. Cl. G06F 17/30

(52) U.S. Cl. 707/200

(57) ABSTRACT

A method includes updating record content included in a database, extracting updated record content during a periodic time interval, producing an internal document that includes data representing the updated record content, producing a file that includes data corresponding to content of the internal document, and sending the file at the periodic time interval.

### BACKGROUND

The present invention relates to data processing by digital computer, and more particularly to extracting record content.

To hire and retain employees, a company, organization or enterprise issues stock options that can be exercised by its employees after a vesting period. Once the vesting period is reached or an exercising window is opened, employees may contact a financial institution to exercise the options. Upon being contacted by one of the employees, the financial institution checks, for example, personal, employment, and other information associated with the employee, along with the number of options granted to the employee prior to exercising the options. Once the employee has exercised some or all of the options granted, the financial institution notifies the company that the employee has exercised the options.

### SUMMARY

In general, in one aspect, the invention features a method that includes (a) updating record content included in a database, (b) extracting updated record content during a periodic time interval, (c) producing an internal document that includes data representing the updated record content, (d) producing a file that includes data corresponding to content of the internal document, and (e) sending the file at the periodic time interval.

Implementations of the invention may include one or more of the following features. The file may include Extensible Markup Language. Updating record content may include adding content. Updating record content may include extending a time period in which the record content is valid. Updating record content may include shortening a time period in which the record content is valid. The periodic time interval may include a day. The periodic time interval may include a week. The record content may include information associated with a participant of a stock option program. The record content may include information associated with stock options granted in a stock option program. The updating, extracting, producing the internal document, producing the file, and sending may be repeated at a second periodic time interval.

In general, in another aspect, the invention features a computer program product, tangibly embodied in an information carrier, the computer program product being operable to cause a machine to update record content included in a database, extract updated record content during a periodic time interval, produce an internal document that includes data representing the updated record content, produce a file that includes data corresponding to content of the internal document, and send the file at the periodic time interval.

Implementations of the invention may include one or more of the following features. The file may include Extensible Markup Language. Updating record content may include adding content. Updating record content may include extending a time period in which the record content is valid. Updating record content may include shortening a time period in which the record content is valid. The periodic time interval may include a day. The periodic time interval may include a week. The record content may include information associated with a participant of a stock option program. The record content may include information associated with stock options granted in a stock option program. The updating, extracting, producing the internal document, producing the file, and sending may be repeated at a second periodic time interval.

In general, in another aspect, the invention features a system that includes a company including a computer system that updates record content included in a database, updated record content is extracted from the database during a period time interval, the computer system produces an internal document that includes data representing the updated record content, the computer system produces a file that includes data corresponding to the content of the internal document, and the file is sent at the periodic time interval.

Implementations of the invention may include one or more of the following features. The file may include Extensible Markup Language. Updating record content may include adding content. Updating record content may include extending a time period in which the record content is valid. Updating record content may include shortening a time period in which the record content is valid. The periodic time interval may include a day. The periodic time interval may include a week. The record content may include information associated with a participant of a stock option program. The record content may include information associated with stock options granted in a stock option program. The updating, extracting, producing the internal document, producing the file, and sending may be repeated at a second periodic time interval.

Other features and advantages of the invention will be apparent from the description and from the claims.

### DESCRIPTION OF DRAWINGS

FIG. 1 is a block diagram depicting companies and a financial institution.

FIG. 2 is a block diagram depicting the content structure of an XML file.

FIG. 3 is a block diagram depicting the content structure of another XML file.

FIGS. 4A-H are timing diagrams depicting updating intervals.

FIG. 5 is a flow chart of a portion of a record extractor.

FIG. 6 is a flow chart of a portion of an HR-XML file production process.

### DETAILED DESCRIPTION

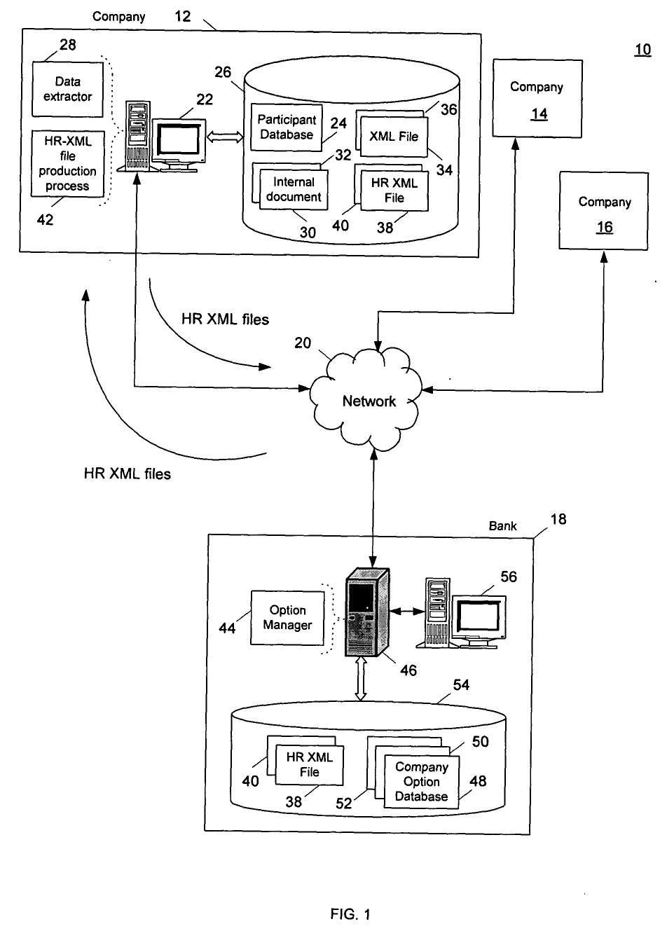

Referring to FIG. 1 a system 10 of related or unrelated companies 12, 14, 16 have employees. Such companies are interested in retaining their current employees and in attracting potential future employees. To retain and attract employees, the companies may issue stock options that typically can be exercised after a vesting period (e.g., 18 months, 3 years, etc.) or during a particular time period (e.g., third quarter 2004). After the vesting period or during the particular time period, participating employees that have been granted stock options can contact a bank 18 or other financial institution that manages the options for the companies. Typically, after being contacted, bank personnel check a database associated with the bank 18 to determine if an employee is a valid participant in the stock option program and, for example, if stock options have been granted to the employee. To check the validity of the employee's identity, along with the number of options granted, the employee's company collects, stores, and sends the appropriate information to the bank 18 for making these and other determinations. Additionally, as such information associated with the employee (e.g., home address, phone number, job title, number of options granted, etc.) changes, the company provides the bank with updated information. Similarly, when an employee attempts to exercise granted options, the bank 18 informs the company associated with the employee.

To provide the bank 18 with employee information for validity checking, each company 12, 14, 16 includes a computer system that communicates with the bank through a network 20 (e.g., the Internet, an intranet, etc.). Focusing on company 12, a computer system 22 (e.g., personal computer, server, mainframe, etc.) associated with the company is in communication with the network 20 so that data can be sent to, and received from, the bank 18. Typically, the data comprises files that include information associated with each participant (e.g., participant name, address, etc.) in the stock option plan provided by the company 12. Some files sent to the bank may include information associated with the options granted to each participant (e.g., shares granted, vesting date, etc.). In this embodiment, the information sent to the bank 18 resides in a participant database 24 that is stored on a storage device 26 (e.g., a hard drive, CR-ROM, etc.) that is in communication with the computer system 22. In some embodiments the database may be produced by a software package such as SAP R/3™, SAP MySAPBusinessSuite™, Microsoft Access™, or other similar package that can be used to categorize and store data.

Typically, the participant database 24 includes multiple records for grouping information associated with each of the participants of the stock option plan. For example, each record may include the full name of one of the participants, the participant's home address, and other information such as the participant's position (e.g., officer, shareholder, etc.) in the company 12, the number of stock options granted to the participant, and the vesting period that restricts exercising of the granted options. The information in the participant database 24 can be relatively quickly updated or modified so that when one participant informs the company 12 that information associated with him or her (e.g., new home address) is no longer accurate, the participant database 24 is updated to store the most current participant information. The company 12 may initiate updating of the participant database 24 to reflect a change in the stored information (e.g., employee promotion, granting additional stock options, etc.).

In order to provide the bank 18 with current information associated stock option participants, one or more files containing the current information may be sent at regular intervals from the company 12, through the network 20, to the bank 18. In some embodiments the regular intervals for sending the one or more files is daily, however, in other embodiments the files may be sent weekly, monthly, or based on other similar time interval. Also, different time intervals may be used in combination. For example, the one or more files may be sent monthly during the summer and holiday months (e.g., August, December, etc.), and on a weekly interval during the rest of the calendar year. By providing the bank 18 with the current information associated with the stock option participants, when a particular participant contacts the bank 18 to exercise stock options granted to him or her, the bank can relatively quickly determine if the participant is a valid participant and if any options granted to the participant may be exercised at the current time.

To initiate sending of the information to the bank 18 at regular intervals, the computer system 22 executes a record extractor 28 that accesses the participant database 24 and retrieves the appropriate record content from the database associated with the participants. In some embodiments, the record extractor 28 retrieves record content from the participant database 24 that is associated with each of the stock option program participants. However, in other embodiments, the record extractor 28 retrieves record content associated with a pre-selected set of participants (e.g., all employees with vested options). In still other embodiments, the record extractor 28 only retrieves record content that has recently been updated, added, or modified so that the bank 18 is provided the current information associated with the altered records. For example, if a participant has updated his or her current home address, the record extractor 28 retrieves the record content associated with this participant for transmitting to the bank 18.

In this particular embodiment, after retrieving the appropriate records, the record extractor 28 produces two files, namely internal documents 30, 32. Internal documents 30, 32, such as SAP intermediate documents (IDoc) that incorporate a standard data structure, are used to provide structured exchanging of business documents. In this particular example, each of the internal documents 30, 32 is stored on the storage device 26, however, in other embodiments the documents are stored in another storage device or in memory included in the computer system 22. The two internal documents 30, 32 produced by the record extractor 28 comply with a human resources (HR) related electronic business standard for inter-company exchange of HR data files that use Extensible Markup Language (XML). This standard is the Employee Stock Plans Interface 1.1 that is promoted by the HR-XML Consortium of Raleigh, N.C., and is incorporated by reference herein. To comply with the standard, the companies 12, 14, 16 transmit two HR-XML files to the bank 18 to provide current information associated with the stock option participants. In this particular example, to comply with the standard, the internal document 30 includes participant information such as contact information (e.g., name, home address, phone number, etc.), associated business information (e.g., office location, employment position, etc.), and other similar information related to the participants. The second internal document 32 typically includes information relating to the participant stock options (e.g., number of options granted, granting option price, etc.) and information relating to vesting of the options (e.g., vesting date, vesting restrictions, etc.), along with other similar information.

After the record extractor 28 retrieves the pertinent records from the participant database 24 and produces the two internal documents 30, 32, an HR-XML file production process 42, which is executed on the computer system 22, accesses the internal documents to produce two corresponding HR-XML files 38, 40 that comply with the HR-XML standard for transmitting the retrieved information to the bank 18. By using the HR-XML standard, the information included in the HR-XML files 38, 40 is formatted such that the bank, or other financial institutions that subscribe to the HR-XML standard, can readily recognize and extract the information from the files. In this embodiment, to produce the HR-XML files 38, 40, the HR-XML file production process 42 accesses data included in the internal documents 30, 32 and enters the data in two XML files 34, 36. Typically, the HR-XML file production process 42 converts each of the internal documents 30, 32 into respective XML files 34, 36 relatively quickly using conversion rules and then maps the data in the XML files into the respective HR-XML files 38, 40. By producing the XML files 34, 36 prior to producing the HR-XML files 38, 40, the HR-XML file production process 42 can map the data included in the XML files into additional files the use formats other than the HR-XML format.

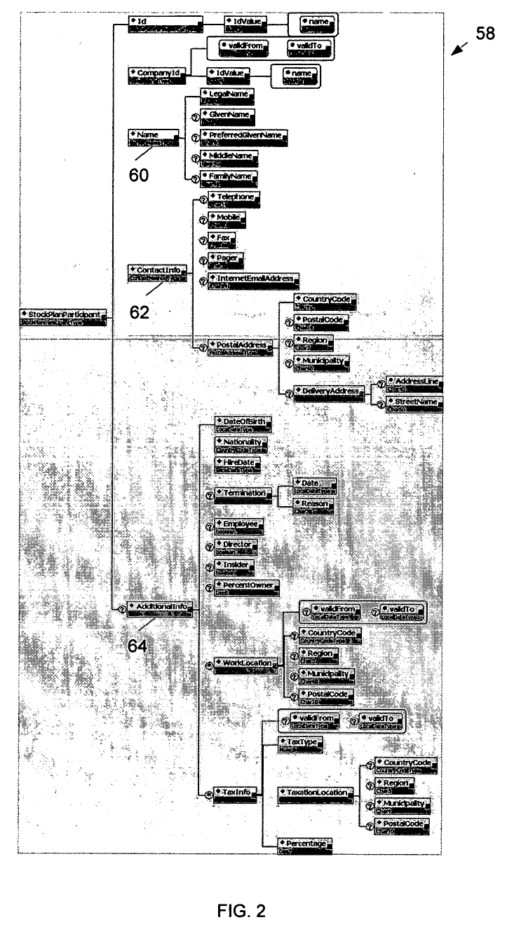

Referring to FIG. 2, an exemplary data structure 58 that is associated with the XML file 34 is shown and includes information associated with a participant of the stock option plan provided by company 12. In this particular example, the data structure 58 includes participant name data 60, contact information 62, and additional data 64 that includes other information associated with the participant. By including this information in the corresponding transmitted HR-XML file 38, the bank 18 can store and use the information to check the identity of a participant requesting to exercise some stock options.

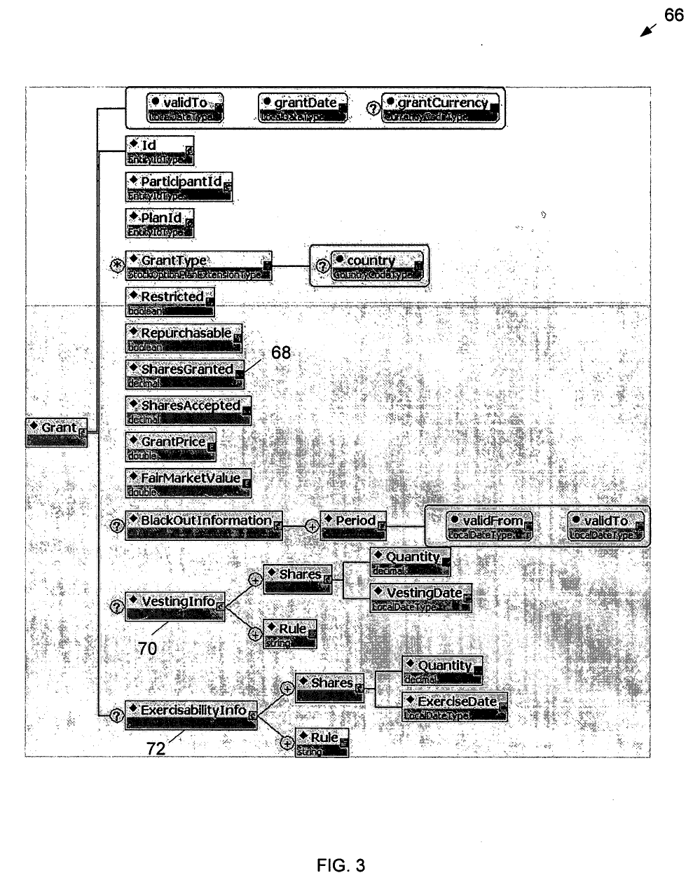

Referring to FIG. 3, an exemplary data structure 66 that is associated with the XML file 36 is shown and includes information associated with the stock options granted to a participant of the stock option plan provided by company 12. In this particular example, the data structure 66 includes the number of shares granted 68, vesting information 70 associated with the granted shares, share-exercising information 72, and other addition information. By including this information in the corresponding transmitted HR-XML file 40, the bank 18 is kept current with regard to status of the options provided to the participant.

Returning to FIG. 1, typically upon producing the two HR-XML files 38, 40 files, the HR-XML file production process 42 stores the files on the storage device 26 along with the XML files 34, 36. Additionally, the HR-XML file production process 42 initiates transmission of the HR-XML files 38, 40 through the network 20 to the bank 18 at a next predetermined time interval for updating the bank. For example, the two HR-XML files 38, 40 may be transmitted to the bank on a daily or weekly basis as previously mentioned, or, the transmission intervals may also be longer or shorter.

Upon receiving the HR-XML files 38, 40, an option manager 44 that executes on a server 46 located at, or in communication with the bank 18, uses the files to update one of the option databases 48, 50, 52 that is associated with the company that sent the files. In this particular example, since company 12 sent the HR-XML files 38, 40, the option database 48 associated with company 12 is updated by the option manager 44. In this example, the HR-XML files 38, 40 are stored on a storage device 54 (e.g., a hard drive, CD-ROM, etc.) that is in communication with the server 46, along with the option databases 48, 50, 52. By storing the HR-XML files 38, 40, on the storage device 54, those files can be retrieved at a later time for additional data processing. For example, a computer system 56 located at the bank 18 and in communication with the server 46 may access the HR-XML files 38, 40 to display particular data included in those files.

In this embodiment, due to the HR-XML standard, the HR-XML files 38, 40 provide the option manager 44 with currently valid participant information as of the time of the file transmission, but the HR-XML files 38, 40 do not include data that reflect future changes in participant information. For example, a participant may inform the company 12 that his or her home address will change, for example, in two months. While the participant database 24 can be modified to reflect the upcoming change, the HR-XML file 38 that includes the participant address that is sent to the bank 18 only provides the current participant address as of the time when the file was transmitted. So, the bank 18 recognizes the address change on the particular date the address change becomes effective (e.g., in two months). Thus, to provide the bank 18 with up-to-date participant information, the record extractor 28 determines if record content in the participant database 24 needs to be modified, modifies the appropriate record content, and stores the modified record content in the participant database so that the HR-XML files produced by the HR-XML file production process 42 include the updated information in this case, the future address change.

Along with receiving HR-XML files 38, 40 from company 12, and HR-XML files from the other companies 14, 16, the bank 18 also receives communications (e.g., telephone calls, facsimile transmissions, etc.) from participants in stock option plans to exercise their granted stock options. Upon receiving an option-exercising request, the bank 18 validates the request with the information stored in the appropriate option database (e.g., option database 48 for requests associated with the company 12). Typically, once the request has been validated, the bank 18 exercises the stock options as requested by the participant. Additionally, to report the option exercising to the respective company, the option manager 44, or another process executing on the server 46, produces an HR-XML file that includes information reflecting the exercising and initiates transmission of the file to the company so that the appropriate participant database is updated.

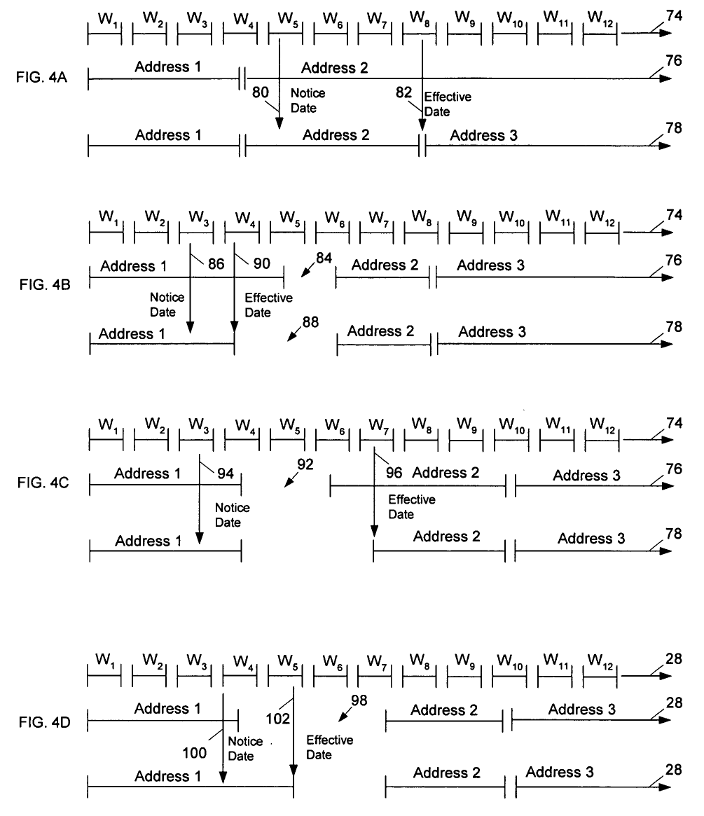

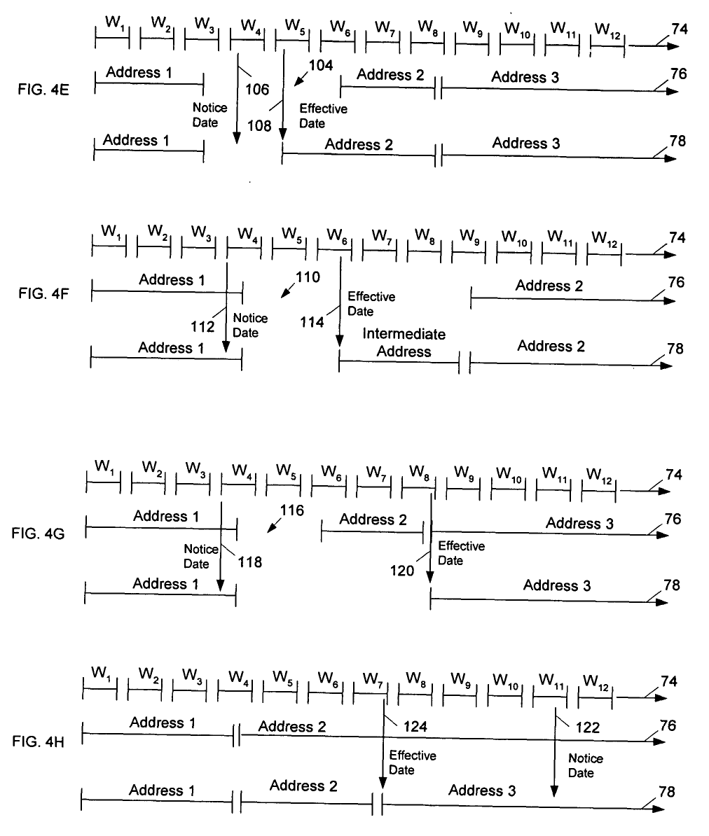

Referring to FIG. 4A-H, a series of timelines demonstrates operations performed by the record extractor 28 to update record content in the participant database 24. As mentioned, since the bank 18 receives HR-XML files that provide valid information as of their transmission time, the record extractor updates the participant database to reflect future changes in the database information. Each of FIGS. 4A-H includes a timeline 74 that represents time intervals during which HR-XML files are transmitted from the company 12 to the bank 18 to provide currently valid information of each participant, or a particular group of participants. In this particular example, a transmission is sent weekly across a series of weeks W₁-W₁₂ and continues with the same weekly interval in the future. However, in other examples, transmissions may be sent on a shorter interval (e.g., daily, hourly, etc.) or on a longer time interval (e.g., monthly, yearly, etc.). Each of FIGS. 4A-H also includes a timeline 76 that represents the current content of a record included in the participant database 24. In this particular example, the record content is the home address of a particular participant. Additionally, each of FIG. 4A-H includes a third timeline 78 that represents the record content after the record is updated based on information received by the company 12 from the participant.

Referring to FIG. 4A, as represented by timeline 76, record content included in the participant database 24 reports that the participant resides at address 1 from week 1 (i.e., W₁) to week 4 (i.e., W₄) and then the participant changes his or her residence to address 2 during week 4 and continues to reside at address 2 thereafter. So, to provide the current address to the bank 18, each week an HR-XML file is sent that includes the current address of the participant at the time of the transmission. For example, during week 1 the bank is informed that the participant resides at address 1 and during week 5 the bank is informed that the participant resides at address 2. Since HR-XML file transmitted to the bank 18 only includes a currently valid address, and does not include data representing future addresses changes, the participant database stored at the company needs to be updated to reflect up-coming address changes.

In this example, the participant informs the company 12 during week 5 (i.e., W₅) that he or she will be residing at a new address, address 3, starting in week 8 (i.e., W₈). Upon being informed on this notice date 80, the record extractor 28 shortens the time period that address 2 is valid and modifies the record content to reflect that address 3 is valid as of an effective day 82 during week 8. By modifying the record content to reflect the future address change, the respective HR-XML files transmitted from company 12 during week 8 and forward provide address 3 as the residence of the participant.

Referring to FIG. 4B, in this example, the timeline 76 represents that the participant resides at or will reside at three address (i.e., address 1, address 2, and address 3). Additionally, from week 5 (i.e., W₅) to week 6 (i.e., W₆) the participant will not have a valid address as represented by a gap 84 in the timeline 76. For example, the participant may be traveling during that time period or residing at a hotel prior to address 2 becoming available. As represented on the timeline 78, the participant provides notice 86 to the company during week 3 (i.e., W₃) that the time gap 84 will be increased to a longer gap 88 that begins during week 4 instead of week 5 thereby shortening the time period that address 1 is valid. Again, since the HR-XML files provide the current participant residence to the bank 18, the record extractor 28 updates the appropriate record content in the participant database 24 on the notice date 86 so that the valid time period for address 1 ends on an effective day 90 during week 4.

Referring to FIG. 4C, a time gap 92 is also present in timeline 76 to reflect that from week 4 (i.e., W₄) to week 6 (i.e., W₆) the participant has no valid address. In this example, the participant informs the company 12 on a day 94 during week 3 that on an effective day 96 address 2 is valid in week 7 instead of week 6. So, based on the shortening of the time period in which address 2 is valid, the HR-XML file sent to the bank 18 during week 6 does not provide address 2 as the current address of the participant.

Referring to FIG. 4D, the timeline 76 includes a gap 98 from week 4 to week 7 to reflect that the participant does not have a valid address during that time period. In this particular content updating example, the participant informs the company 12 on day 100 that address 1 is valid until an effective date 102 in week 5 (i.e., W₅) instead of ending during week 4 (i.e., W₄). So, an HR-XML file sent from the company 12 during week 5 informs the bank 18 that address 1 is the current address of the participant.

Referring to FIG. 4E, the timeline 76 again reports a gap 104 between the time periods that address 1 or address 2 are valid. However, in this particular example of the record extractor 28 updating record content included in the participant database 24, the participant informs the company 12 on a day 106 included in the gap 104 that address 2 has an effective start day 108 in week 5 (i.e., W₅) instead of week 6 (i.e., W₆). Due to the extending of the time period in which address 2 is valid, an HR-XML file sent from the company 12 during week 5 includes data representing that address 2 is the current address of the participant.

Referring to FIG. 4F, the time line 76 includes a gap 110 that extends from week 4 (i.e., W₄) to week 9 (i.e., W₉) and represents that the participant will not have a valid address during this time period. However, on a day 112 at the start of week 4 (i.e., W₄) the participant informs company 12 that on an effective day 114 in week 6 (i.e., W₆), he or she will be residing at an intermediate address prior to beginning residence at address 2 during week 9 (i.e., W₉). So, in this particular example, the record extractor 28 adds a new address to the record content stored in the participant database 24 so that as the weekly HR-XML files are sent to the bank 18 for weeks 6, 7, and 8, each appropriate file reports that the intermediate address is the residence of the participant.

Referring to FIG. 4G, the timeline 76 shows a gap 116 to represent a time period in which the participant has not established an address. Additionally, the timeline 76 shows that the participant is planning on residing at three different addresses (i.e., address 1, address 2, address 3) at different time intervals beginning with week 1. Again, at weekly intervals the record extractor 28 determines the address where the participant is currently residing and includes that information in an HR-XML file that is transmitted to the bank 18. However, in this particular example, during a day 118 in week 4 (i.e., W₄) the participant informs the company 12 that he or she will not be residing at address 2 during weeks 6, 7, and 8. Thus, the next valid address after address 1 is address 3 and the gap 116 now extends into week 8 (i.e., W₈) instead of ending in week 6 (i.e., W₆). So, based on the information provided on the day 118, the record extractor 28 removes the record content associated with the participant residing at address 2, and updates the record content to reflect that on a day 120 during week 8 (i.e., W₈) residency begins at address 3.

Referring to FIG. 4H, in this particular example, the participant informs the company 12 of an address change after the address change has already taken effect. As represented on timeline 76, record content in the participant database 24 represents that the participant resides at address 1 from week 1 (i.e., W₁) until week 4 (i.e., W₄) and then resides at address 2 from week 4 (i.e., W₄) forward. However, on a day 122 in week 11 (i.e., W₁₁), the participant informs the company 12 that he or she started residing at address 3 effective on a day 124 in week 7 (i.e., W₇). Since the participant informed the company 12 of the address change after the effective date 124 had already arrived, it was not possible for the record extractor 28 to include data representing address 3 in the weekly HR-XML file transmissions to the bank 18. But, the record extractor 28 can modify the record content to reflect the past address change and the current address of the participant on the day 122 the company 12 is notified. So, while the HR-XML files sent during week 7, 8, 9, and 10 were incorrect, the files sent for weeks 11, 12, and onward include data that represents that the participant is residing at address 3.

In each of the FIG. 4A-H, one particular address-updating scenario was demonstrated. However, in some arrangements, the record extractor may update record content based on two or more of the scenarios. Furthermore, in FIG. 4A-H, the address of the stock option plan participant was updated in the participant database 24, however, in other arrangements other record content included in the participant database is updated. For example, record content associated with vesting periods, exercising options, or other similar information is updated individually or in combination.

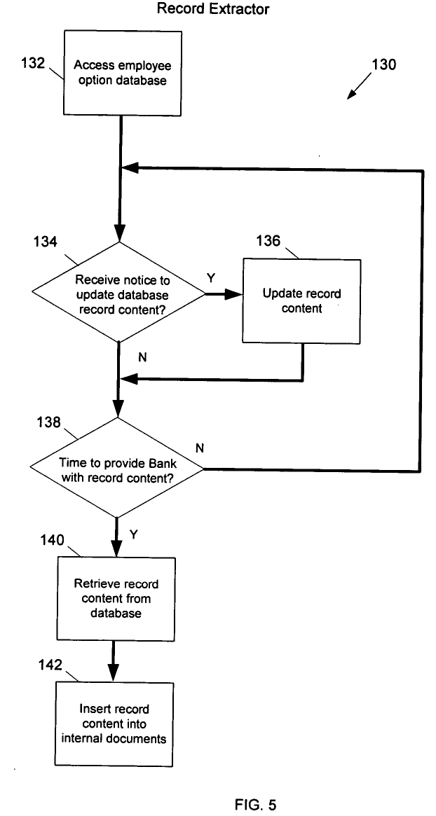

Referring to FIG. 5, a flowchart for a portion of a record extractor 130, such as the record extractor 28 includes accessing (132) a participant database such as the participant database 24 stored on the storage device 26 at the company 12. The record extractor 130 also determines (134) if a notice has been received to update record content in the participant database. For example, notice may be provided by a participant of the stock option program or by the company managing the stock option program. In some examples, as mentioned, the received notice informs the record extractor 28 that information (e.g., home address, stock option shares granted, etc.) represented in the record content included in the participant database needs to be updated. If it is determined that notice has been received, the record extractor 130 updates (136) the record content in the database to reflect the appropriate information. For example, the record extractor 130 may update record content as described in conjunction with FIGS. 4A-H. Furthermore, in some arrangements, the received notice includes information associated with two or more updates of record content of the participant database.

After updating the appropriate record content, or if it is determined that no notice for updating has been received, the record extractor 130 determines (138) if the appropriate time has arrived to provide the bank, or one or more other financial institutions, with the currently valid record content included in the participant database. However, in some arrangements the record extractor 130 provides the bank with only the currently valid record content that has been updated since the last HR-XML file transmission to the bank. Typically, the time interval for HR-XML file transmissions is weekly, however in other arrangements the interval may be longer (e.g., monthly, bi-yearly, etc.) or may be shorter (e.g., daily, hourly, etc.). If it is determined that the time has not arrived to provide the bank with the currently valid record content in the database, the record extractor 130 returns to determine (134) if a notice has been received. If determined that the appropriate time has arrived, the record extractor 130 retrieves (140) the appropriate record content from the participant database and inserts (142) the retrieved record content into an internal document associated with participant information and an internal document associated with the granted stock options.

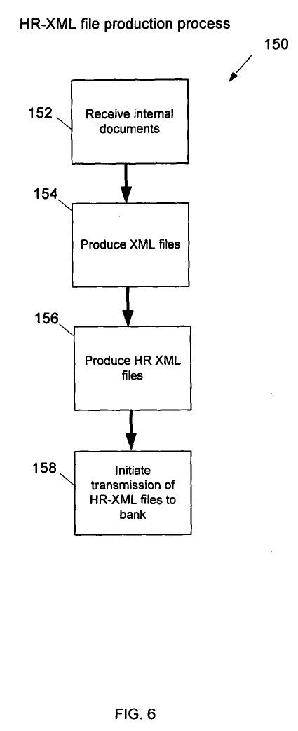

Referring to FIG. 6, a flow chart for a portion of an HR-XML file production process 150 includes receiving (152) internal documents that include participant information and granted stock option information. In some arrangements, two internal documents are received from a storage device, such as the storage device 26, and were produced by the data extractor 28 executed on the computer system 22 at the company 12. After the internal documents are received, the HR-XML file production process 150 produces (154) XML files that include data representing the content of the internal documents. For example, the HR-XML file production process 150 produces an XML file that includes data representing participant information included in one of the received internal document and a second XML file that includes data representing information associated with stock options granted that is included in the other internal document. Typically, each of the XML files produced are also stored on a storage device such as the storage device 24.

After producing the XML files, the HR-XML file production process 150 respectively produces (156) HR-XML files for each produced XML file. For example, the HR-XML file production process 150 produces an HR-XML file that includes data representing the content of the XML file that includes participant information and also produces a second HR-XML file that includes data representing content of another XML file that includes stock option information. After producing the HR-XML files, the HR-XML file production process 150 typically stores the files on a storage device such as the storage device 24 and initiates (158) the transmission of the HR-XML files to the bank 18 or to one or more other financial institutions that manage the stock option program for the company sending the files.

The record extractor 130 along with other processes such as the HR-XML file production process 150 can be implemented in digital electronic circuitry, or in computer hardware, firmware, software, or in combinations of them. The processes can be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps of the processes can be performed by one or more programmable processors executing a computer program to perform functions of the record extractor by operating on input data and generating output. Method steps can also be performed by, and apparatus of the record extractor can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer include a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

The processes can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the record extractor, or any combination of such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

Other implementations are also within the scope of the following claims.

1. A method comprising:
updating record content included in a database;
extracting updated record content during a periodic time interval;
producing an internal document that includes data representing the updated record content;
producing a file that includes data corresponding to content of the internal document; and
sending the file at the periodic time interval.

2. The method of claim 1, wherein the file includes Extensible Markup Language.

3. The method of claim 1, wherein updating record content includes adding content.

4. The method of claim 1, wherein updating record content includes extending a time period in which the record content is valid.

5. The method of claim 1, wherein updating record content includes shortening a time period in which the record content is valid.

6. The method of claim 1, wherein the periodic time interval includes a day.

7. The method of claim 1, wherein the periodic time interval includes a week.

8. The method of claim 1, wherein the record content includes information associated with a participant of a stock option program.

9. The method of claim 1, wherein the record content includes information associated with stock options granted in a stock option program.

10. The method of claim 1, further comprising:
repeating the updating, extracting, producing the internal document, producing the file, and sending at a second periodic time interval.

11. A computer program product, tangibly embodied in an information carrier, the computer program product being operable to cause a machine to:
update record content included in a database;
extract updated record content during a periodic time interval;
produce an internal document that includes data representing the updated record content;
produce a file that includes data corresponding to content of the internal document; and
send the file at the periodic time interval.

12. The computer program product of claim 11, wherein the file includes Extensible Markup Language.

13. The computer program product of claim 11, wherein updating record content includes adding content.

14. The computer program product of claim 11, wherein updating record content includes extending a time period in which the record content is valid.

15. The computer program product of claim 11, wherein updating record content includes shortening a time period in which the record content is valid.

16. The computer program product of claim 11, wherein the periodic time interval includes a day.

17. The computer program product of claim 11, wherein the periodic time interval includes a week.

18. The computer program product of claim 11, wherein the record content includes information associated with a participant of a stock option program.

19. The computer program product of claim 11, wherein the record content includes information associated with stock options granted in a stock option program.

20. The computer program product of claim 11, being further operable to cause a machine to:
repeat the updating, extracting, producing the internal document, producing the file, and sending at a second periodic time interval.

21. A system comprising:
a company including a computer system that updates record content included in a database, updated record content is extracted from the database during a period time interval, the computer system produces an internal document that includes data representing the updated record content, the computer system produces a file that includes data corresponding to the content of the internal document, and the file is sent at the periodic time interval.

22. The system of claim 21, wherein the file includes Extensible Markup Language.

23. The system of claim 21, wherein updating record content includes adding content.

24. The system of claim 21, wherein updating record content includes extending a time period in which the record content is valid.

25. The system of claim 21, wherein updating record content includes shortening a time period in which the record content is valid.

26. The system of claim 21, wherein the periodic time interval includes a day.

27. The system of claim 21, wherein the periodic time interval includes a week.

28. The system of claim 21, wherein the record content includes information associated with a participant of a stock option program.

29. The system of claim 21, wherein the record content includes information associated with stock options granted in a stock option program.

30. The system of claim 21, wherein the updating, extracting, producing the internal document, producing the file, and sending is repeated at a second periodic time interval.
